(19) United States
(12) Patent Application Publication
(10) Pub. No.: US 2005/0040564 A1
(43) Pub. Date: Feb. 24, 2005

(54) Systems and methods for using norbornene based curable materials

(76) Inventors: Jones Oliver, Corvallis, OR (US); Isaac Farr, Corvallis, OR (US); Terry M. Lambright, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/642,971

(22) Filed: Aug. 18, 2003

(51) Int. Cl. B29C 35/08

(52) U.S. Cl. 264/494; 264/109; 425/174.4

(57) ABSTRACT

Solid freeform fabrication (SFF) systems for producing a three-dimensional object and methods of producing three-dimensional objects are disclosed. One exemplary SFF system, among others, includes a dispensing system and a curing system. The dispensing system includes a norbornene based curable material and is adapted to dispense the norbornene based curable material. The curing system is operative to cure the norbornene based curable material.

### BACKGROUND

Solid freeform fabrication (SFF) or layer manufacturing (LM) is a fabrication technology that builds an object of any complex shape layer by layer or point by point without using a pre-shaped tool (die or mold). This process begins with creating a Computer Aided Design (CAD) file to represent the geometry of a desired object. SFF technology enables direct translation of the CAD image data into a three-dimensional object. SFF technology can be used in applications such as verifying CAD database, evaluating design feasibility, testing part functionality, assessing aesthetics, checking ergonomics of design, aiding in tool and fixture design, creating conceptual models and sales/marketing tools, generating patterns for investment casting, reducing or eliminating engineering changes in production, and providing small production runs.

One SFF technique involves adding or depositing a build composition to form predetermined areas of a layer essentially point-by-point; but a multiplicity of points may be deposited at the same time in some techniques (e.g., ink-jet technology). These predetermined areas together constitute a thin section of a three-dimensional object as defined by a CAD geometry. Successive layers are then deposited in a predetermined sequence with a layer being affixed to its adjacent layers forming an integral three dimensional, multi-layer object.

Typically, a SFF system includes a dispensing system such as an ink-jet dispensing system, a curing system, and a build platform. The build composition is stored within a compartment of the ink-jet dispensing system as a mixture of an initiator and a build material. The build composition is dispensed (i.e., jetted) onto the build platform from an ink-jet printhead of the ink-jet dispensing system. Currently, epoxy and acrylate based material systems are used in many SFF systems.

### SUMMARY

Briefly described, embodiments of this disclosure include solid freeform fabrication (SFF) systems for producing three-dimensional objects. One exemplary SFF system, among others, includes a dispensing system and a curing system. The dispensing system includes a norbornene based curable material and is adapted to dispense the norbornene based curable material. The curing system is operative to cure the norbornene based curable material.

Methods of producing three-dimensional objects are also provided. One exemplary method includes, among others includes the following steps: providing a norbornene based curable material including at least one initiator and at least one norbornene based build material, dispensing the norbornene based curable material onto a build platform, and curing the norbornene based curable material to produce the three-dimensional object.

In addition, methods of forming a solid freeform fabrication system are provided. One exemplary method includes, among others, includes the following steps: providing a dispensing system including at least one ink-jet printhead and a curing system; and disposing a norbornene based curable material into one of the at least one ink-jet printheads.

### BRIEF DESCRIPTION OF THE DRAWINGS

Many aspects of the invention can be better understood with reference to the following drawings. The components in the drawings are not necessarily to scale. Moreover, in the drawings, like reference numerals designate corresponding parts throughout the several views.

FIG. 1 illustrates an embodiment of a solid freeform fabrication (SFF) system.

FIG. 2 illustrates a perspective view of an embodiment of a SFF apparatus.

FIG. 3 is a representative flow diagram for forming an object using the embodiment of the SFF system shown in FIGS. 1 and 2.

FIG. 4 illustrates an exemplary embodiment of a ring opening metathesis polymerization (ROMP) initiator.

FIGS. 5A and 5B illustrate exemplary embodiment of norbornene structures.

FIG. 6 illustrates an exemplary embodiment of a dicyclopentadiene structure.

### DETAILED DESCRIPTION

Norbornene based curable materials, methods of application thereof, and systems for using the norbornene based curable materials are provided. In particular, the embodiments relate to the use of norbornene based curable materials in the manufacture of three-dimensional objects by solid freeform fabrication (SFF) systems and methods. The term three-dimensional object refers to objects that are sufficiently rigid to maintain a fixed volume and shape to an extent, which is appropriate for use in SFF systems.

The norbornene based curable material includes, but is not limited to, one or more norbornene based build materials and one or more initiators. The norbornene based curable material can include a single-part or a multi-part norbornene based curable material. The norbornene based curable material or components thereof in a multi-part norbornene based curable material, can be dispensed onto a build platform and cured to form the three-dimensional object in a layer-by-layer fashion. For example, the components of the multi-part norbornene based curable materials are stored separately within the SFF system and are dispensed in an independent manner onto a build platform. Thereafter, the components are commingled to form the multi-part norbornene based curable material and then one or more layers of the multi-part norbornene based curable material are cured. This process is repeated until the three-dimensional object is formed.

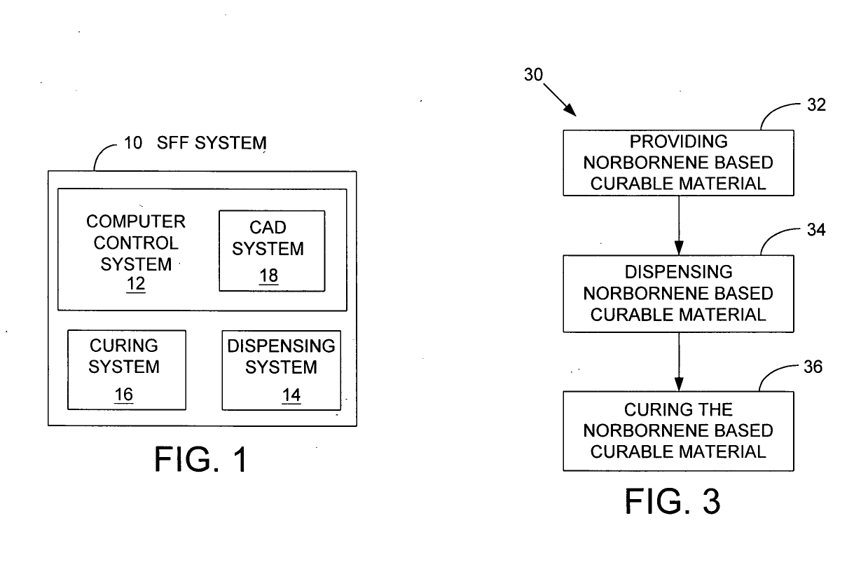

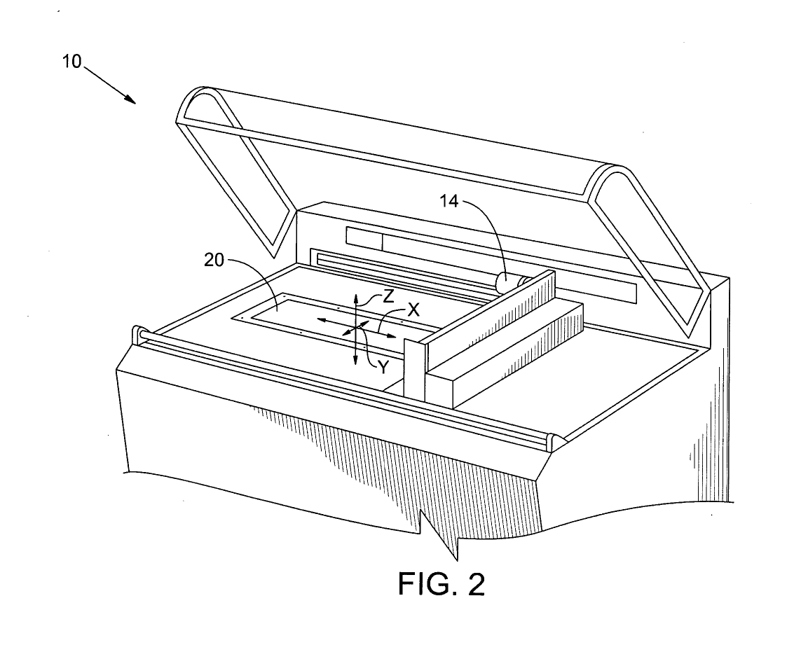

FIG. 1 illustrates a block diagram of a representative SFF system 10 that includes a computer control system 12, a dispensing system 14, and a conventional curing system 16. FIG. 2 illustrates a perspective view of the SFF system 10 shown in FIG. 1. The computer control system 12 includes a process control system that is adapted to control the dispensing system 14, the curing system 16 (e.g., an ultraviolet (UV)radiation, a visible radiation, and/or a thermal curing system), and optionally a positioning system and a build platform temperature control system. In addition, the computer control system 12 includes, but is not limited to, a Computer Aided Design (CAD) system 18 or other SSF CAD-related systems.

The dispensing system 14 includes, but is not limited to, conventional ink-jet technologies and conventional coating technologies. Ink-jet technology, such as drop-on-demand and continuous flow ink-jet technologies, can be used to dispense chemical compositions onto a build platform 20 (FIG. 2). The dispensing system 14 can include at least one conventional ink-jet printhead (e.g., thermal ink-jet printhead and/or a piezo ink-jet print head) adapted to dispense (e.g., jet) one or more chemical compositions through one or more of a plurality of ink-jet printhead dispensers. In addition, the ink-jet printhead can include a plurality of ink-jet compartments (e.g., tanks or wells for containing the components) that are capable of holding the norbornene based curable materials or components thereof, where the compartments are fluidically coupled to the ink-jet printhead dispensers. The ink-jet printhead dispenser can be heated to assist in dispensing viscous chemical compositions. For example, the ink-jet printhead dispenser can be heated up to about 200° C., and preferably in the range of 70 to 120° C.

In one embodiment, the dispensing system 14 includes a separate ink-jet printhead for each component of the norbornene based radiation curable material. For example, a two-part norbornene based curable material may include two ink-jet printheads, where one holds an initiator and one holds a norbornene based build material. In another example, a three-part norbornene based radiation curable material may include three ink-jet printheads, where one holds an initiator, a second holds a first norbornene based build material, and the second includes a second norbornene based build material. Disposing the components of the norbornene based curable material into different ink-jet printheads allows the components to be heated to different temperatures, which is advantageous when the viscosity of the one or more of the components need to be decreased to enhance the dispensement of the build material.

The SFF system 10 can be incorporated into processes that are used to fabricate or construct three-dimensional objects in an iterative layered process. The computer control system 12 is capable of being selectively adjusted to control the output from the dispenser system 14, which controls the thickness and pattern of each component in each layer of the iterative process.

In embodiments that have one or more norbornene based build materials and one or more initiators, the initiators and the norbornene based build materials can be dispensed onto the build platform 20 in a variety of patterns. The patterns can take the form of, but not limited to, alternating layers of the initiators and the norbornene based build materials, alternating offset-checkerboard layers of the initiators and the norbornene based build materials, and alternating side-by-side strips of the initiators and the norbornene based build materials. In addition, other patterns are possible using two or more printheads. Moreover, the patterns of the components of the norbornene based curable material can vary depending on the volume or drop-size of the dispensed components. In this regard, multiple ink-jet printhead passes (e.g., scans) across the build platform 20 can be conducted to achieve the appropriate spacing of the components of the norbornene based curable material.

In general, the volume (e.g., drops) of the norbornene based curable material disposed from the dispensing system 14 is from about 0.1 picoliters to 500 picoliters, about 0.1 picoliters to 100 picoliters, and about 0.1 picoliters to 35 picoliters. However, the desirable ejected volume of the norbornene based curable material depends on a number of factors such as, but not limited to, the concentration, the viscosity, and the chemical characteristics of the components of the norbornene based curable material; the temperature of the build platform 20; the volume ratio between the components of the norbornene based curable material; the desired resolution (e.g., 600 drops per inch), and the design of the print-head firing chamber.

FIG. 3 is a flow diagram describing a representative method 30 for forming an object using the SFF system 10. The norbornene based curable material or components thereof (in a multi-part norbornene based curable material) are provided, as shown in block 32. The norbornene based curable material or components thereof can be stored in one or more compartments in one or more ink-jet printheads in the dispensing system 14. For example when the norbornene based curable material is a multi-part norbornene based curable material, the components in a norbornene based curable material can be stored in different compartments of a single ink-jet printhead or stored in different ink-jet printheads. The norbornene based curable material or components thereof are dispensed through one or more ink-jet printhead dispensers either simultaneously or in a step-wise manner, as shown in block 34. If the norbornene based curable material is a multi-part norbornene based curable material, then the components are commingled on the build platform 20 of the SFF system 10 to form the norbornene based curable material.

After one or more layers of the norbornene based curable material are dispensed (e.g., simultaneously or sequentially from one or more print heads) onto the build platform 20, the curing system 16 can be used to cure, or partially cure, the norbornene based curable material, as shown in block 36. Then the process is repeated as necessary to produce the object of interest in a layer-by-layer fashion. To enhance layer-to-layer adhesion, it may be useful to only partially cure each layer during the fabrication process. A full cure could be accomplished by placing the object in a curing box or other appropriate device after removal from the fabrication tool. In addition, the curing process can be performed after the layers of the norbornene based curable material are disposed on the build platform 20 (e.g., flood exposure or scan exposure). Furthermore, the curing process can be performed in a substantially contemporaneous manner by scan exposing the norbornene based curable material as the norbornene based curable material or components thereof are dispensed onto the build platform 20.

As discussed above, the norbornene based curable material can be a single-part or a multi-part norbornene based curable material and can include, but is not limited to, one or more norbornene based build materials and one or more initiators. Polymerization of the norbornene based curable material can be achieved using the inherent reactivity of the components of the norbornene based curable material and/or external stimulation such as, but not limited to, ultraviolet (UV) radiation, visible radiation, and/or thermal energy. The norbornene based curable material includes chemical components that are compatible for use with ink-jet technologies.

In embodiments having the single-part norbornene based curable material, the norbornene based build material and the initiator can be pre-mixed and then disposed into the ink-jet printhead or mixed in the ink-jet printhead. In embodiments having the multi-part norbornene based curable material, the norbornene based build material and the initiator can be added directly to the ink-jet printhead.

In general, the norbornene based curable material or the components thereof have the characteristic that the chemical has a viscosity (i.e., a jettable viscosity) less than 50 cps at a temperature below about 200° C. and preferably less than 20 cps at a temperature below about 170° C.

In addition, the norbornene based curable material should be able to form a “tack free” layer within about 5 seconds to 10 minutes at a temperature below about 100° C. Preferably, the norbornene based curable material should be able to form a “tack free” layer within about 5 seconds to 1 minute at a temperature below about 60° C. The term “tack free” is defined as the point where the crosslinking/chain growth reaction has progressed such that the resulting material is no longer tacky to the touch. It does not imply that curing/chain growth is complete.

As is known in the art, the viscosity of the build material can generally be lowered by increasing its temperature. Therefore, the ink-jet printhead can be heated to lower the viscosity of the norbornene based curable material or the components thereof. The use of higher temperatures can allow more viscous higher molecular weight materials to be used as one or more components of the norbornene based curable material, which can provide for more desirable mechanical properties of the solid three-dimensional object upon cooling. However, the ink-jet printhead should not be heated to temperatures that exceed: (a) the boiling point of the norbornene based curable material or the components thereof; (b) the temperature of thermal decomposition of the norbornene based curable material or the components thereof, used; and (c) the temperature of the the norbornene based curable material or the components thereof, to achieve thermal activation.

In general, the norbornene based curable material can include additional chemical components such as, but not limited to, colorants (e.g., dyes, pigments, inks), dispersants, and catalysts to optimize the reaction time of the norbornene based curable material or the components thereof, fillers (e.g., calcium sulphate, titanium dioxide, carbon black, clay, and organoclays), thixotropic agents (e.g., ceramic particles, nanoparticles, hydrophobic and hydrophilic fumed silica), antioxidants, surfactants, and solvents. Additional components can be used in the norbornene based curable material to obtain the proper balance of cure rate, layer-to-layer adhesion, toughness, and glass transition temperature, of the three-dimensional object. In addition, the components can be used to alter the physical and/or chemical properties (e.g., viscosity, reactivity, surface tension, bubble formation, and wetting of the ejection chamber) of the norbornene based curable material or components thereof prior to and/or after being dispensed.

The initiator functions to initiate and/or contribute to the polymerization of the norbornene based build material. The initiator can include, but is not limited to, one or more ring opening metathesis polymerization (ROMP) initiators, one or more radical initiators, and/or one or more photo initiators (e.g., UV and visible initiators).

The ROMP initiators can include, but are not limited to, ruthenium, osmium, titanium, and molybdenum, and combinations thereof, based catalysts. In general, ruthenium and osmium based catalysts are water stable and have good tolerance toward many of the functional groups that are included in norbornene based build materials. In particular, the ruthenium based catalysts can include, but are not limited to, Ru(H₂O)₆(toluene-4-sulfonate)₂ and Ru(arene)₂(toluene-4-sulfonate)₂. In addition, the ruthenium based catalysts can include, but are not limited to, ruthenium phosphine complexes. For example, an exemplary ruthenium phosphine complex can be formed in situ by combining Ru(p-cymene)Cl₂ and P(cyclohexyl)₃ on the build platform 20 of the SFF system 10 in which a multi-part norbornene based curable material is being used.

In addition, the ROMP initiator can include, but is not limited to, metal-carbene complexes. The metal in the metal-carbene complex can include, but is not limited to, tungsten, molybdenum, ruthenium, titanium, tantalum, osmium, iridium and rhenium, and combinations thereof.

Furthermore, the ROMP initiator can include, but is not limited to, ruthenium benzylidene complexes such as benzylidene-bis(tricyclohexylphosphine) dichlororuthenium, which is illustrated in FIG. 4.

Additionally, the ROMP initiator can include, but is not limited to, heteroatom substituted catalysts such as (PCy₃)₂Cl₂Ru=CHSPh and (P(i-Pr)₃)₂Cl₂Ru=CHSPh. Other ROMP initiators are described in the following patents: U.S. Pat. No. 5,831,108, U.S. Pat. No. 5,342,909, U.S. Pat. No. 5,710,298, U.S. Pat. No. 5,312,940, U.S. Pat. No. 5,750,815, U.S. Pat. No. 5,880,231, U.S. Pat. No. 5,849,851, and U.S. Pat. No. 4,883,851.

The radical initiator can include, but is not limited to, azo compounds and peroxide compounds (with and without accelerators). The azo compounds can include compounds such as, but not limited to, 2,2′-azo (bisisobutyronitrile) and 1,1′-diphenyl-1,1′-diacetoxyazoethane. The peroxide compounds can include compounds such as, but not limited to, diacyl peroxides (e.g., dibenzoyl peroxide and di-tert-butyl peroxide), alkyl hydroperoxides, and their esters, peroxyesters, and persulfates. The radical initiators can be mixed with accelerator compounds (e.g., amines) and reducing agents (e.g., Fe(II), Ag, and Cu(II)) to produce the radical complexes used in the polymerization of the norbornene based build material

The UV initiator can include chemicals such as, but not limited to, a free radical initiator. The free-radical initiator includes compounds that produce a free radical on exposure to UV radiation. The free-radical is capable of initiating a polymerization reaction. Exemplar free-radical initiators include, but are not limited to, benzophenones (e.g., benzophenone, methyl benzophenone, Michler's ketone, and xanthones), acylphosphine oxide type free radical initiators (e.g., 2,4,6-trimethylbenzoyldiphenyl phosphine oxide (TMPO), 2,4,6 -trimethylbenzoylethoxyphenyl phosphine oxide (TEPO), and bisacylphosphine oxides (BAPO's)), benzoins, bezoin alkyl ethers (e.g., benzoin, benzoin methyl ether and benzoin isopropyl ether), benzil ketals (e.g., 2,2-dimethyloxy-2-phenylacetophenone), acetophenone (a,a-diethyoxy acetophenone), and aromatic ketone/co-initiator (e.g., benzophenones and alcohols, amines, thiols or combinations thereof.) The free-radical initiator can be used alone or in combination with a co-initiator. Co-initiators are used with initiators that need a second molecule to produce a radical that is active in UV-systems. For example, benzophenone uses a second molecule, such as an amine, to produce a reactive radical. A preferred class of co-initiators are alkanolamines such as, but not limited to, triethylamine, methyldiethanolamine and triethanolamine.

The visible initiator can include, but is not limited to, α-diketones (e.g., camphorquinone, 1,2-acenaphthylenedione, 1H-indole-2,3-dione, 5H-dibenzo[a,d]cycloheptene-10, and 11-dione), phenoxazine dyes (e.g., Resazurin, Resorufin), acylphosphine oxides, (e.g., diphenyl(2,4,6-trimethylbenzoyl) phosphine oxide), and the like.

The use of the initiator with the norbornene based build material is advantageous for at least the following reasons. First, many norbornene based build materials have low viscosities (0.75 cP at 50° C.) and therefore, can be easily jetted. Second, the functionality of the norbornene based build material can be changed to enhance one or more characteristics such as, but not limited to, toughness, glass transition temperature, coefficient of thermal expansion, crosslink density, adhesion, solubility, latent reactivity, low moisture absorption, chemical resistance, optical transparency, heat resistance, and modulus and elongation. In addition, a wide variety of three-dimensional product properties can be obtained from the same starting materials by altering the ratio of the one or more norbornene based build materials and one or more initiators. Third, since the norbornene based build materials have a low viscosity, additional materials (e.g., builders, higher molecular weight polymers, fillers, and thixotropic agents, that increase the viscosity) can be added to the norbornene based build material to affect one or more characteristics of the resulting norbornene based curable material. Fourth, the norbornene based build material and the initiator can be used as a single-part curable material or a multi-part curable material in the SFF system. Fifth, a wide variety of initiators can be used to induce polymerization of the norbornene based build material. Six, the norbornene based build material and initiator can be induced to polymerize using photopolymerization, co-initiators, and/or thermal polymerization.

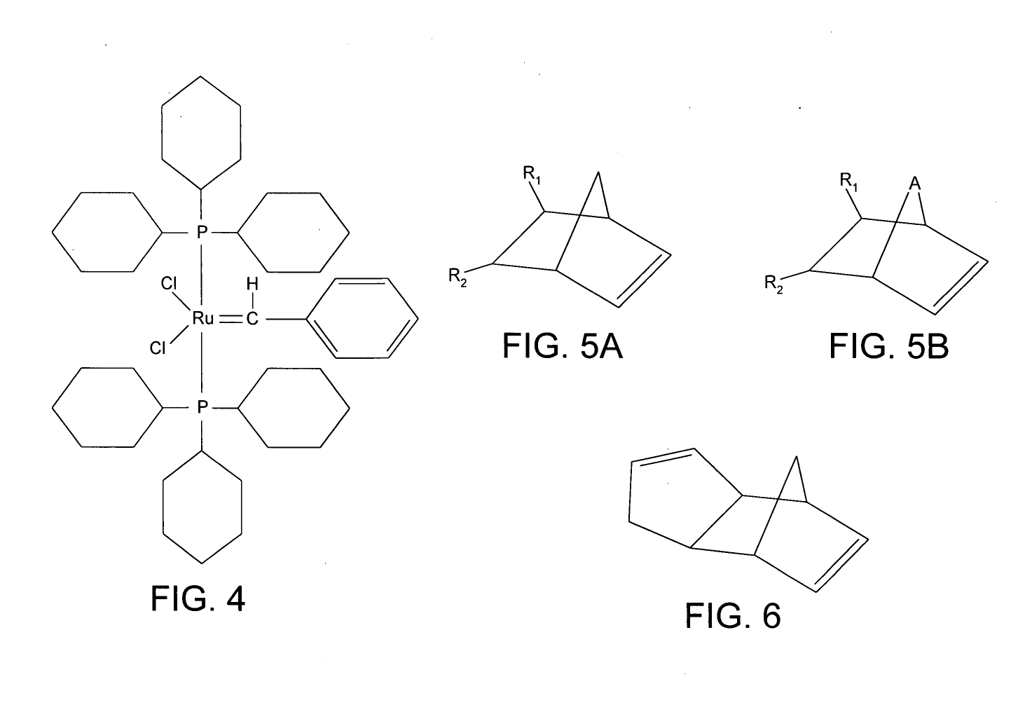

The norbornene based build material can include norbornene compounds such as, but not limited to, functionalized norbornene compounds (endo and exo isomers) and functionalized hetero-norbornene compounds (endo and exo isomers). The functionalized norbornene compounds and functionalized hetero-norbornene compounds are illustrated in FIGS. 5A and 5B, respectively. The functional groups R₁ and R₂ can include, but are not limited to, hydrogen, an acetate functional group, an alcohol functional group, an alkyl functional group, an aldehyde functional group, an anhydride functional group, an epoxide functional group, an ester functional group, an ether functional group, a ketone functional group, a nitrile functional group, a silyl-ether functional group, and a phenyl functional group. The heteroatom “A” in the functionalized hetero-norbornene compound shown in FIG. 5B can include, but is not limited to, oxygen, nitrogen, and sulfur.

In particular, the norbornene based build material can include, but is not limited to, tetraethylene glycol mono (2′-norbornene-5′-exo-ylmethyl) ether, 5-norbornene-2-exo-ylmethyl-6-diethyl phosphate ester, 5-norbornene-2-exo-ylmethyl-6-diethyl triethyl ammonium salt, n-alkyl norbornene dicarboxyimides (e.g., n=2-9 and 11), 2-norbornene-5-tert-butylester, 2-norbornene-5,6-dimethyldiester, 2-norbornene-5-methylester, substituted oxa-benzonorbornenes (e.g., 5,6-di(trifluoromethyl)-7-oxa-norbornene), 5,5-dimethyl norbornene, 5,6-dimethyl norbornene, 1-methyl norbornene. In addition, the norbornene based build material can include dicyclopentadiene (FIG. 6).

Additionally, the photocurable functional groups (e.g., acrylate functional groups) can be added to the norbornene based build material to enhance crosslinking between the layers of norbornene based curable material as they are disposed on the build platform 20. In other words, the polymerization of norbornene based build material can be caused to occur as each layer of the norbornene based curable material is disposed onto the build platform 20. Subsequently, the photocurable functional groups can be caused to polymerize and cause additional crosslinking to occur between the plurality of layers. An exemplary compound having photocurable functional groups includes, but is not limited to, acylated 2-norbornene methanol.

The norbornene based curable material can include additional compounds such as, but not limited to, acrylic compounds, compounds having one or more epoxy substituents, one or more vinyl ether substituents, vinylcaprolactam, vinylpyrrolidone, urethanes, and combinations thereof, to enhance one or more characteristics of the norbornene based curable material or the resulting three-dimensional object. In particular, monomers of these compounds can be used in conjunction with the norbornene based build material. In addition, oligomers of these compounds, which may not have been considered previously because of their high viscosity in single-part build material, can be used with the norbornene based curable build material. In this regard, the increased viscosity latitude allows higher molecular weight materials, which may result in better mechanical properties (e.g., material stiffness/flexibility and strength, and resistance to impact) in the final three-dimensional object. One skilled in the art could select additional compounds to be used in conjunction with the norbornene based curable material that satisfy the desired mechanical properties of a particular application.

Suitable acrylic compounds can include, but are not limited to, an acrylic monomer, an acrylic oligomer, an acrylic crosslinker, or combinations thereof. An acrylic monomer is a monofunctional acrylated molecule, which can be, for example, esters of acrylic acid and methacrylic acid. An acrylic oligomer (an oligomer is a short polymer chain) is an acrylated molecule, which can include, but is not limited to, polyesters of acrylic acid and methacrylic acid and a polyhydric alcohol (e.g., polyacrylates and polymethacylates of trimethylolpropane, pentaerythritol, ethylene glycol, propylene glycol). In addition, the acrylic oligomer can be a urethane-acrylate.

An acrylic crosslinker is a polyfunctional molecule, which provides enhanced crosslinking. Examples of acrylic crosslinkers includes, but is not limited to, 1,4-butanediol diacrylate, 1,4-butanediol dimethacrylate, 1,6-hexamethylene glycol diacrylate, neopentyl glycol dimethacrylate, trimethylol propane trimethacrylate, pentaerythritol triacrylate, penta-erythritol trimethacrylate, triethylene glycol triacrylate, triethylene glycol trimethacrylate, urethane acrylate, trimethylol propane triacrylate, and urethane methacrylates.

The norbornene based curable material can also be used in conjunction with one or more chemicals having one or more vinyl ether substituents such as, but not limited to, vinyl ether monomers and oligomers having at least one vinyl ether group. Exemplary vinyl ethers include, but are not limited to, ethyl vinyl ether, propyl vinyl ether, isobutyl vinyl ether, cyclohexyl vinyl ether, 2-ethylhexyl vinyl ether, butyl vinyl ether, ethyleneglycol monovinyl ether, diethyleneglycol divinyl ether, butane diol divinyl ether, hexane diol divinyl ether, cyclohexane dimethanol monovinyl ether, and 1,4 cyclohexane dimethanol divinyl.

The norbornene based curable material can also be used in conjunction with one or more chemicals having one or more epoxy substituents such as, but not limited to, epoxy monomers and oligomers having at least one oxirane moiety. Examples of epoxy-containing build materials include, but are not limited to, bis-(3,4-cyclohexylmethyl carboxylate), 3,4-epoxy cyclohexylmethyl carboxylate, 3,4-epoxycyclohexyl carboxylate, diglycidyl ether vinylcyclohexene, 1,2-epoxy-4-vinylcyclohexane carboxylate, 2,4-epoxycyclohexylmethyl carboxylate, 3,4-epoxy cyclohexane carboxylate, and the like.

In general, the norbornene based curable material and/or components thereof can be carried and/or dissolved into a liquid vehicle that is compatible with ink-jet technologies. For example the liquid vehicle can include, but is not limited to, water, solvents, biocides, and sequestering agents. For example, the norbornene based curable material and/or components thereof can be dissolved in one or more solvents, such as, but not limited to, inert volatile solvents such as aliphatic and aromatic hydrocarbons of lower molecular weight, volatile alcohols, ethers, and esters, and high boiling point plasticizers (e.g., dibutyl phthalate). In another embodiment, the norbornene based curable material and/or components thereof can be dissolved in a solvent such as, but not limited to, low reactivity monomers/low viscosity monomers, such as low molecular weight monofunctional alkyl acrylates and alkyl methacrylates (e.g., allyl methacrylate, isodecyl acrylate and methacrylate, isooctyl acrylate), hydroxyalkyl acrylates and methacrylates (e.g., 2-hydroxyethyl methacrylate), glycidyl methacrylate, isobornyl acrylate, and the like.

The volume of the components in the norbornene based curable material can vary greatly depending, at least in part, on the type of initiator, the type of norbornene based build material, and the type of solvent, as well as the types of other components in the norbornene based curable material. One skilled in the art can determine the necessary volume of each of the components in the norbornene based curable material.

In embodiments having multi-part norbornene based curable materials, the volume of the components can vary greatly. For example, when the multi-part norbornene based curable material is a two part norbornene based curable material, the volume of the initiator relative to the volume of the norbornene based build material dispensed onto the build platform 20 can range from about 1 part initiator to 100 parts of the norbornene based build material. Although in some embodiments it may be 1 part of the initiator to 10 parts of the norbornene based build material, while in still others it may be 1 part of the initiator to 1 part of the norbornene based build material. The ratio of the volumes of the components can be controlled by the drop volume and/or the number of drops of the components.

It should be noted that viscosity, temperature, ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range.

Many variations and modifications may be made to the above-described embodiments. All such modifications and variations are intended to be included herein within the scope of this disclosure and protected by the following claims.

1. A method of producing a three-dimensional object, comprising the steps of:
providing a norbornene based curable material including at least one initiator and at least one norbornene based build material;
dispensing the norbornene based curable material onto a build platform; and
curing the norbornene based curable material to produce the three-dimensional object.

2. The method of producing a three-dimensional object of claim 1, wherein the norbornene based curable material is a single-part norbornene based curable material.

3. The method of producing a three-dimensional object of claim 1, wherein the norbornene based curable material is a multi-part norbornene based curable material.

4. The method of producing a three-dimensional object of claim 3, further comprising:
dispensing the at least one initiator and the at least one norbornene based build material onto the build platform independently, wherein the at least one initiator and the at least one norbornene based build material are commingled to form a multi-part norbornene based curable material.

5. The method of producing a three-dimensional object of claim 4, wherein dispensing includes:
dispensing a layer of the at least one norbornene build material; and
dispensing a layer of the initiator onto the layer of the at least one norbornene build material thereby forming the multi-part norbornene based curable material.

6. The method of producing a three-dimensional object of claim 4, wherein dispensing includes:
dispensing a layer of the initiator; and
dispensing a layer of the norbornene based build material onto the layer of initiator thereby forming the multi-part norbornene based curable material.

7. The method of producing a three-dimensional object of claim 4, wherein dispensing the initiator and the norbornene based build material is performed sequentially.

8. The method of producing a three-dimensional object of claim 4, wherein dispensing the radiation initiator and the build material is performed simultaneously.

9. The method of producing a three-dimensional object of claim 4, wherein dispensing the initiator and the norbornene based build material further comprises:
dispensing the initiator from a first ink-jet printhead and dispensing the norbornene based build material from a second ink-jet printhead.

10. The method of producing a three-dimensional object of claim 1, wherein the initiator is selected from ring opening metathesis polymerization initiators, radical initiators, photo initiators, and combinations thereof.

11. The method of producing a three-dimensional object of claim 1, wherein the norbornene based build material is selected from functionalized norbornene compounds, functionalized hetero-norbornene compounds, dicyclopentadiene, and combinations thereof.

12. A solid freeform fabrication system for producing a three-dimensional object, comprising:
a dispensing system including a norbornene based curable material, wherein the dispensing system is adapted to dispense the norbornene based curable material; and
a curing system operative to cure the norbornene based curable material.

13. The solid freeform fabrication system of claim 12, wherein the norbornene based curable material includes at least one initiator and at least one norbornene based build material.

14. The solid freeform fabrication system of claim 12, wherein the dispensing system includes at least one ink-jet printhead.

15. The solid freeform fabrication system of claim 14, wherein a first ink-jet printhead includes the initiator in a first compartment and the norbornene based build material in a second compartment.

16. The solid freeform fabrication system of claim 14, wherein a first ink-jet printhead includes the initiator and a second ink-jet printhead includes the norbornene based build material.

17. The solid freeform fabrication system of claim 16, wherein the initiator is selected from ring opening metathesis polymerization initiators, radical initiators, photo initiators, and combinations thereof.

18. The solid freeform fabrication system of claim 16, wherein the initiator includes a ring opening metathesis polymerization initiator.

19. The solid freeform fabrication system of claim 12, wherein the norbornene based build material is selected from functionalized norbornene compounds, functionalized hetero-norbornene compounds, dicyclopentadiene, and combinations thereof.

20. The solid freeform fabrication system of claim 12, wherein the norbornene based build material includes a dicyclopentadiene.

21. The solid freeform fabrication system of claim 12, further comprising a computer control system operative to control the dispensing system and the curing system.

22. The solid freeform fabrication system of claim 12, wherein the curing system is selected from an ultraviolet curing system, a visible curing system, and a thermal curing system.

23. A method of forming a solid freeform fabrication system, comprising:
providing a dispensing system including at least one ink-jet printhead and a curing system; and
disposing a norbornene based curable material into one of the at least one ink-jet printheads.

24. The method of forming a solid freeform fabrication system of claim 23, wherein the norbornene based curable material includes at least one initiator and at least one norbornene based build material.

25. The method of forming a solid freeform fabrication system of claim 24, further comprising:
dispensing the initiator in a first compartment of the ink-jet printhead; and
dispensing the norbornene based build material in a second compartment of the ink-jet printhead.

26. The method of forming a solid freeform fabrication system of claim 24, further comprising:
dispensing the initiator in a first ink-jet printhead; and
dispensing the norbornene based build material in a second ink-jet printhead.

27. The method of forming a solid freeform fabrication system of claim 24, further
comprising:
mixing the at least one norbornene based build material and the at least one initiator; and
dispensing the mixture of the at least one norbornene based build material and the at least one initiator into the ink-jet printhead.

28. The method of forming a solid freeform fabrication system of claim 24, wherein the initiator is selected from ring opening metathesis polymerization initiators, radical initiators, photo initiators, and combinations thereof.

29. The method of forming a solid freeform fabrication system of claim 24, wherein the norbornene based build material is selected from functionalized norbornene compounds, functionalized hetero-norbornene compounds, dicyclopentadiene, and combinations thereof.

30. The method of forming a solid freeform fabrication system of claim 24, wherein the norbornene based build material includes a dicyclopentadiene.
